(19) United States
(12) Patent Application Publication
(10) Pub. No.: US 2011/0157184 A1
(43) Pub. Date: Jun. 30, 2011

(54) IMAGE DATA VISUALIZATION

(76) Inventors: Wolfgang Niehsen, Bad Salzdetfurth (DE); Stephan Simon, Sibbesse (DE)

(21) Appl. No.: 13/000,282

(22) PCT Filed: Nov. 18, 2008
(86) PCT No.: PCT/EP08/65748

§ 371 Date: Mar. 17, 2011

(30) Foreign Application Priority Data
Jun. 20, 2008 (DE) 10 2008 002 560.7

(51) Int. Cl. G06T 11/20

(52) U.S. Cl. 345/440

(57) ABSTRACT

A method, a device, a system, and a computer program product for visualizing image data, about which there exists at least one piece of additional information are described. The steps performed for visualizing include displaying the image data as an image data image having pixels, the display further including: superimposed with respect to the image data image, at least partial display of additional information corresponding to individual pixels for generating an image data image enriched with and/or superimposed with additional information. Corresponding components are provided for visualization, in particular a display device designed for displaying further information such as additional information and the like superimposed with respect to the image data.

### FIELD OF THE INVENTION

The present invention relates to a method for visualizing image data, in particular image data having at least one piece of additional information. In addition, the present invention relates to a computer program including program code for performing all the steps of the method and a computer program product including program code stored in a computer-readable medium to perform the method according to the present invention. The present invention also relates to a device for visualizing image data, in particular image data having at least one piece of additional information. In addition, the present invention relates to a system for visualizing image data having at least one piece of additional information.

### BACKGROUND INFORMATION

The present invention is directed to a method, a device, a computer program, a computer program product and a system for visualizing image data. The objects of the present invention are also driver assistance systems, monitoring camera systems, camera systems for an aircraft, camera systems for a watercraft or a submarine vehicle or the like in which image data are represented.

German Patent Application No. DE 102 53 509 A1 describes a method and a device for warning the driver of a motor vehicle. A visual warning is generated via a signaling component within the field of vision of the driver in the direction of at least one object in the vehicle surroundings, the visual warning occurring at least before the object becomes visible to the driver. The visual warning is at least one light spot and/or at least one warning symbol, at least the duration of the display being variable. In this approach, objects are recognized and a signal is generated in the form of symbols for the object. The signal is transmitted to the driver, e.g., acoustically or visually.

### SUMMARY

The method, device, system and computer program according to the present invention as well as the computer program product according to the present invention for visualizing image data, may have the advantage that the image data or an image data image generated therefrom, enriched, in particular superimposed, by appropriate additional information such as, for example, distance information, is transmitted to a user.

The user is able to directly recognize the relevance of the image data, objects and the like from this additional information, such as distance information or other information, for example, to fulfill a driving task (braking, accelerating, following, etc.). The user may thus comprehend the additional information more rapidly through the superimposed display of additional information (distance information, etc.) and image data. Relevant data, inference, etc., for example, in fulfilling a task, for example, a driving task, may thus be eliminated in a suitable manner so that the user is able to perceive this task intuitively and respond appropriately even when confronted with an increased information density. Visualization is possible without recognizing objects because additional information is displayed generally for each pixel or all image data. A more rapid visualization is thus implemented. Not lastly, an aesthetically attractive display of relevant information is possible.

It is advantageous in particular that the additional information is displayed classified, in particular through a difference in coloration, texture, brightness, darkening, sharpening, magnification, increased contrast, reduced contrast, omission, virtual illumination, inversion, distortion, abstraction, with contours, in a chronologically variable manner (moving, flashing, vibrating, wobbling) and the like both individually and in combination, depending on the classification. The classification allows the relevant information to be displayed superimposed over the image data image in a manner that is easier for the user to comprehend. The classification also permits a faster and simpler processing of the combination of image data and additional information. Problems, details or additional information may be derived from the appropriate classes, so that it is superfluous to search in all the image data, in particular to search visually, so that the processing rate is increased and/or the visual detection is accelerated.

It is another advantage of the present invention that the additional information is additionally displayed in a processed representation at least partially above and/or next to the image data, in particular as a histogram or the like. The variety of information (image, distance and other information) may thus be represented in a compressed form in which it is easily comprehensible for the user and in particular also for further processing.

The additional information and/or the image data is/are preferably represented in a smoothed form in which the classified information is represented showing fuzzy borders between the neighboring classes. This is advantageous in particular in the case of image points where there is a substantial jump from one class to another. A fluid emphasis or representation may be implemented in this way. Thus a soft transition, for example, a visually soft transition, is implemented in the representation. The additional information may be smoothed prior to enrichment of or superpositioning on the image. This also makes it possible to average out errors in an advantageous manner. Smoothing may be performed with regard to time or place or both time and place. Smoothing allows the information content to be reduced to a suitable extent. To minimize or prevent an impression of fuzziness associated with smoothing, additional lines and/or contours, for example, object edges, object contours, etc., may be represented by using a Canny algorithm, for example, which finds and provides dominant edges of the camera image, for example.

It is advantageous that transitions, for example, edges of objects, are represented for a sharp localization of fuzzy additional information. Clear, sharp visualizations are generated in this way, despite fuzziness, in colors, for example.

The device and system according to the present invention for visualizing image data may have the advantage that rapid and easily comprehensible information processing is implementable with an aesthetically appealing execution for the user through the use and/or implementation of the method according to the present invention.

It is also advantageous that a display device is included, which is designed to display further information such as additional information and the like in enriched form and/or superimposed with respect to the image data. The additional information includes all information, including information relating to distance, for example. Information derived therefrom is also to be included here. For example, this may include changes in distance over time, for example, distance divided by changes in distance (also TTC—time to collision), and the like. This information may in general also include other data, for example, which is displayed in a suitable form superimposed on the image data.

It may be advantageous in particular if the device or the system has at least one interface for coupling to system components that are to be connected such as a driver assistance system, a motor vehicle, additional sensors, and the like. This yields numerous possible uses for optimized approaches to suitably supported tasks.

The method is advantageously implemented as a computer program and/or a computer program product. This includes all computer units, in particular also integrated circuits such as FPGAs (field programmable gate arrays), ASICs (application specific integrated circuits), ASSPs (application specific standard products), DSPs (digital signal processors) and the like, as well as hardwired computer modules.

A suitable method for faster image processing is preferably used for the method, the device, the computer program, the computer program product and the system. A suitable method may be a method for visualizing image data based on disparities. More specifically, a method for processing image data of a disparity image, in particular a disparity image obtained in a stereo video-based system and produced by stereo video-based raw image data, present in at least two raw image data images, at least one corresponding piece of distance information, in particular disparity information being present for at least one data point of the image data. To perform an image data-dependent task, the method includes the steps: transmitting the image data to a processing unit and processing the image data, so that generally all image data are classified before being processed with respect to their distance information in order to reduce the complexity for further processing based on the classification of pixels. This has the advantage that (image) data or an image data image generated therefrom may be processed directly, i.e., without object grouping or object transformation. The processing is performed with respect to distance information available for individual pieces of image data or raw image data available with respect to the image data. Distance information is generally available for each pixel, preferably a disparity. A disparity is understood in general to refer to the offset resulting when using a stereo video camera system in comparison with the pixels resulting for a space-time point on the different camera images, each pixel and/or disparity having a clear-cut relationship to the particular distance of the space-time point from the camera. For example, the disparity may be based on the focal length of the cameras and may be expressed as the quotient of the offset of the pixels corresponding to a space-time point expressed in image coordinates, and the focal length of the camera. This disparity is the reciprocal of the distance of the space-time point from a reference location such as a reference point, a reference area (e.g., in the case of a rectified camera), a reference surface and the like and may be expressed as the following ratio, for example, by taking into account the basic spacing of the cameras among one another, i.e., the distance of the cameras from one another: the quotient of disparity and camera focal length corresponds to the quotient of the basic width and the distance from the space-time point. The space-time point corresponds to the actual point of an object in the surroundings. The pixels represent the space-time point detected by sensors in a camera image or an image data image, for example, a pixel image, which is defined by x and y coordinates in the pixel image. All the image data are preferably located in a Cartesian coordinate system in accordance with their disparity and their position, given in x coordinates and y coordinates, preferably in a Cartesian coordinate system, where they are assigned to a class, i.e., are classified, in particular being characterized in the same way, and are thus displayed for a user and/or transmitted to a further processing unit. This makes it possible to implement faster classification and thus faster processing of (raw) data. Furthermore, the two-dimensional representation on a display gains information content by additionally showing the depth direction, which cannot be represented per se, by superpositioning. This method is applicable to image data of a disparity image. Raw image data for creating a camera image, for example, may be used after being processed appropriately to form a disparity image, may be discarded after processing or may be used in combination with the disparity image. In this method, the classification is performed in such a way that the (raw) image data are subdivided/organized into multiple classes, preferably into at least two classes, more preferably into at least three classes. The following conclusions are easily reached on the basis of the classification into two or more classes, for example, three classes, in the case of a driver assistance system, for example, in which disparity information or distance information is assigned to pixels from vehicle surroundings: the corresponding pixel corresponds to a real point or a space-time point, which belongs generally to a plane, a surface or a roadway, for example, or to a tolerance range thereto in which a user such as a vehicle is situated and/or moving. In other words, this space-time point is in a reference class or in a reference plane. The real roadway surface corresponds only approximately to a plane. It is in fact more or less curved. The term reference plane is therefore also understood to be a reference surface or reference area designed generally, i.e., approximately, to be planar. If the vehicle is moving on this reference plane or reference surface or is situated in or on this reference plane, there is no risk of collision between the vehicle and the points classified as belonging to the reference plane. In addition, the pixel may correspond to a space-time point which is situated outside, in particular above or below, the reference plane or reference class. The point may be at such a height or distance from the reference plane that there is the possibility of a collision with the point. The corresponding space-time point is thus a part of an obstacle. After appropriate processing of the data, a warning may be output or other corresponding measures may be initiated. The pixel may also correspond to a space-time point, which is situated at a distance from the reference plane, so there is no possibility of a collision or interference. These situations may thus change according to a chronological sequence and/or movement sequence, so that repeated classifications of the image data are performed. This method according to the present invention does not require any training phases. The classification is performed without any knowledge of the appearance of objects. No advance information about properties such as size, color, texture, shape, etc. is required, so it is possible to respond quickly to new situations in the surroundings.

The (raw) image data may be classified in intermediate classes according to a suitable method if the (raw) image data are classifiable in different classes, for example, if a disparity value is close to a corresponding decision threshold for a classification, i.e., if no definite classification is possible, sufficient information is not available, interference occurs, or the limits are not sharply defined. Even if a space-time point is represented only on one image data image, then this image data value may be assigned to an intermediate class. Thus, instead of a sharp separation of the predetermined classes, a soft separation may also be performed. The separation may be soft, i.e., continuous, or it may be stepwise in one or more classes. Furthermore, the (raw) image data may be classified in classes relevant for solving a driving problem, in particular selected from the group of classes including: risk of collision, no risk of collision, flat, steep, obstacle, within an area of a reference, below a reference, above a reference, at the side of a reference, relevant, irrelevant, unknown, unclassifiable and the like. This allows extremely fast processing of the (raw) image data which may be made accessible to the driver in an easily comprehensible manner, for example, by display. Classification permits a reduction in information, so that only the relevant data need be processed for faster and further processing and it is possible to respond rapidly accordingly. In addition, the (raw) image data images may be at least partially rectified prior to the disparity determination and/or classification. In particular it is advantageous if an epipolar rectification is performed. The rectification is performed in such a way that the pixels of a second image data image, for example, of a second camera, corresponding to a pixel in a row y of a first image data image, for example, of a first camera, is situated in the same row y in the image data image of the second image, so it is assumed here without any restriction on general validity that the cameras are situated side by side. The distance of the space-time point from the cameras may then be determined from a calculation of the displacement of the so-called disparities of the two points along the x axis, and corresponding distance information may be generated for each pixel. It is advantageous in particular if a full rectification is performed, so that the relationship between the disparity and the distance is the same for all pixels. Furthermore, the classification with respect to the distance information may include classification with regard to a distance from a reference in different directions in space. It is thus possible to calculate a disparity space on the basis of which a suitable classification of the image data of the real surroundings may be easily performed. The disparity space may be spanned by the different directions in space, which may be selected to be any desired directions. The directions in space are preferably selected according to a suitable coordinate system, for example, a system spanned by an x axis, a y axis and a d axis (disparity axis), but other suitable coordinate systems may also be selected. Furthermore, at least one reference from the following group of references may be selected from the image data: a reference point, a reference plane, a reference area, a reference surface, a reference space, a reference half-space and the like, in particular a reference area or a reference plane. A tolerance range is preferably determined next to the reference plane. Pixels situated in this tolerance range are determined as belonging to the reference plane. The reference plane or reference area in particular is ascertained as any reference plane with regard to its orientation, position, curvature and combinations thereof and the like. For example, a reference plane may stand vertically or horizontally in the world. In this way, objects in a driving tube or a driving path, for example, may be separated from objects offset therefrom, for example, to the right and left. The reference planes may be combined in any way, for example, a horizontal reference plane and a vertical reference plane. Likewise, oblique reference planes may also be determined, for example, to separate a step or an inclination from corresponding objects on the step or inclination. It is also possible to use surfaces having any curvature as the reference plane. For example, relevant or interesting objects and persons on a hill or an embankment may be easily differentiated from objects or persons not relevant or not of interest, for example, at a distance therefrom. This method may be implemented as a computer program and/or a computer program product. This includes all computer units, in particular also integrated circuits such as FPGAs (field programmable gate arrays), ASICs (application specific integrated circuits), ASSPs (application specific standard products), DSPs (digital signal processors) and the like as well as hardwired computer modules.

### BRIEF DESCRIPTION OF THE DRAWINGS

Exemplary embodiments of the present invention are shown in the figures and explained in greater detail below.

FIG. 1 schematically shows an example of a superimposed representation of image data image and additional information for the objects classified as relevant.

FIG. 2 schematically shows a camera image.

FIG. 3 schematically shows the disparity image according to FIG. 2 with additional information (disparities).

FIG. 4 schematically shows a pixel-by-pixel classification of the image data of a camera image.

FIG. 5 schematically shows three images from different steps for visualization of a traffic situation.

FIG. 6 schematically shows three images from different steps for visualization of another traffic situation.

FIG. 7 schematically shows three images from different steps for visualization of another traffic situation.

FIG. 8 schematically shows an image of a visualization in a first parking situation.

FIG. 9 schematically shows an image of a visualization in a second parking situation.

FIG. 10 schematically shows an image of a visualization in a third parking situation.

FIG. 11 schematically shows an image of a visualization in a fourth parking situation.

FIG. 12 schematically shows three scales supplementing the visualization.

FIG. 13 schematically shows a visualization of a traffic situation using a supplementary histogram.

FIG. 14 schematically shows a visualization of a traffic situation using lightening of pixels instead of coloration.

FIG. 15 schematically shows three different configurations for a camera.

FIG. 16 schematically shows different configurations for a stereo video system in a passenger motor vehicle.

### DETAILED DESCRIPTION OF EXAMPLE EMBODIMENTS

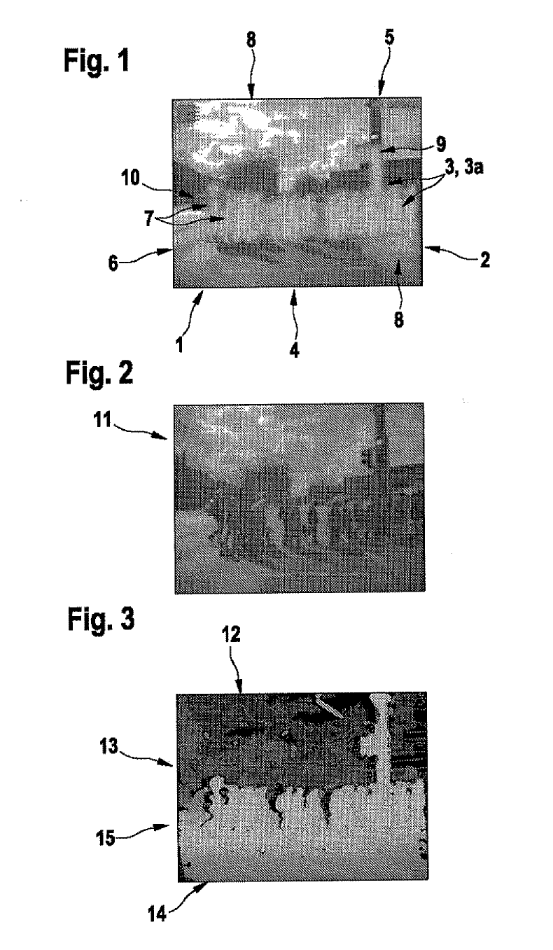

FIG. 1 schematically shows an example of a superimposed representation of image data image 1 and additional information 2 for objects 3, which are classified as relevant. In the present exemplary embodiments, the additional information includes primarily distance information and/or information for fulfilling a driving task, other additional information also being included. The exemplary embodiment shown here relates to a driver assistance system. Using a camera system, in particular a stereo video camera system, i.e., a camera system having at least two cameras offset from one another, the surroundings of a driver in a vehicle having the camera system, namely here in the front viewing area, are detected. The surroundings represent a traffic situation in which another vehicle on a road 4 is stopped at a traffic light 5 in front of a pedestrian crosswalk 6, where several pedestrians 7 are crossing road 4. The image of this traffic situation is reproduced for the driver on a display device, namely a display screen here. Furthermore, additional information 2 in the form of distance information is superimposed on or added to image data 1. Additional information 2 is represented here on the basis of different colors. In the present example, additional information 2, which is emphasized by a color, is not assigned to or superimposed on each pixel, but instead is assigned only to those pixels which are relevant for a driving task, namely pixels showing collision-relevant objects 3a. The collision relevance is ascertained, for example, from a distance from a camera of the camera system and the particular pixel coordinate. More specifically, this information may be ascertained on the basis of the distance from a plane in which the projection centers of the camera are situated. In the present case, the collision-relevant objects include pedestrian group 7, a curbstone 8, traffic light post 9 and vehicle 10 crossing in the background. These are emphasized accordingly, preferably by color. The image superimposed in FIG. 1 is generated from the image shown in FIG. 2 and that shown in FIG. 3.

FIG. 2 schematically shows a camera image 11, for example, from a camera of a stereo video system. The present image was recorded using a monochromatic camera, i.e., a camera having one color channel and/or intensity channel, but it may also be recorded using a color camera, i.e., a camera having multiple color channels. Cameras having a spectral sensitivity extending into at least one color channel in a range not visible for humans may also be used. The image according to FIG. 3 is superimposed on camera image 11 shown in FIG. 2, or camera image 11 is enriched with corresponding additional information 2. The superpositioning may be accomplished by any method, for example, by mixing, masking, nonlinear linking, and the like.

FIG. 3 schematically shows an image according to FIG. 2 having additional information 2, preferably disparities. The image according to FIG. 3 was obtained using a stereo camera system. A disparity is shown for generally each pixel in the image according to FIG. 3. The disparities of the pixels are represented here by colors, where the cooler colors (i.e., colors having a longer wavelength, preferably dark blue in the present case—for reference numeral 12) are assigned to great distances from the camera, and the warmer colors (i.e., the colors having a shorter wavelength) are assigned to the distances closer to the camera, but any assignment of colors may be chosen. If no disparity may or should be assigned to one pixel, it is characterized using a defined color, for example, black (or any other color or intensity). To obtain the disparities, corresponding pixels of multiple camera images from different sites are processed. On the basis of the shift of the corresponding points between the different camera images, the distance of the corresponding pixel in the real surroundings (space-time point) is determined by triangulation. If there is already a disparity image, it may be used directly without prior determination of distance. The resolutions of the multiple cameras may be designed differently, for example. The cameras may be situated at any distance from one another, for example, one above the other, side by side, with a diagonal offset, etc. The more cameras are used, the greater is the achievable quality of the image for the visualization. To obtain the additional information 2, other sensors may also be used in addition to or instead of the stereo video system, for example, LIDAR sensors, laser scanners, range imagers (e.g., PMD sensors, Photonic Mixing Device), sensors utilizing the transit time of light, sensors operating at wavelengths outside of the visible range (radar sensors, ultrasonic sensors), and the like. Sensors supplying an image of additional information 2, in particular many pieces of additional information for the different directions in space, are preferred.

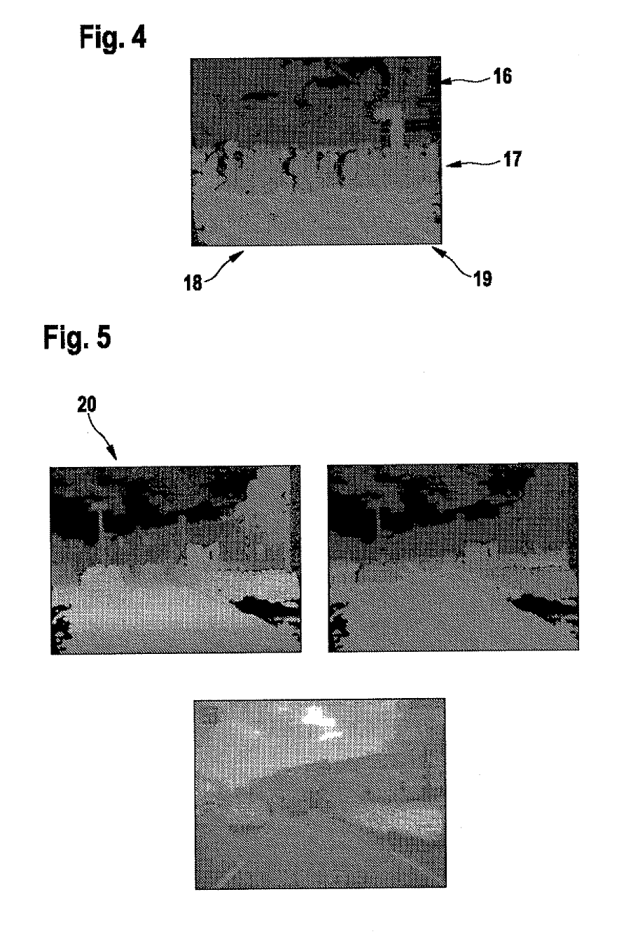

In FIG. 3 additional information 3 or distance information is not displayed as color coded distances but rather as color coded disparities, there being a reciprocal relationship between the distances and disparities. Therefore the color in the far range (for example, blue—at reference numeral 13) changes only slowly with the distance, whereas in the near range (for example, red to yellow—reference numerals 14 to 15) a small change in distance results in a great change in color. The disparities may be classified for simpler perception by a user, for example, a driver. This is shown on the basis of FIG. 4.

FIG. 4 schematically shows a pixel-by-pixel classification of the image data of a camera image 11. FIG. 4 shows the pixels in a certain color for which it has been found that collision-relevant obstacles are located there. Any color, for example, red (at reference numeral 14) is used as the color to characterize these pixels. Since the colors of FIG. 4 are provided only for processing and not for the driver, the color or other characterization may be freely selected as desired.

The classifications of the image data or the particular objects in the image according to FIG. 4 have the following meanings in particular: class I or class high—at reference numeral 16—for example, the color blue: the object is very high or is far outside of a reference plane and thus is irrelevant with respect to a collision; class II or class relevant—at reference numeral 17—for example, the color red: the object or obstacle is at a collision-relevant height; class III or low class, for example, —at reference numeral 18—the color green: the object or obstacle is flat and therefore is irrelevant with respect to a collision.

In addition to main classes 16, 17 and 18, additional classes (e.g., “low”) or intermediate classes 19, which are characterized by hues of color in between, may be determined. FIG. 4 shows, for example, in intermediate class 19 with a preferred yellow-brown and violet coloration to identify curbstones 8, pedestrian walkways or traffic light poles 9 or objects at a height of approximately 2.5 meters. These classes 19 characterize transitional areas. In addition, a “low” class may be determined, including ditches, precipices, potholes, or the like, for example.

The visualization in which only the points where there is an obstacle (class II 17, preferably shown in red) is now shown advantageously in particular as superimposed on the camera image. The non-collision-relevant classes are not superimposed, i.e., only camera image 11, preferably shown without coloration, is visible there. Accordingly, classes up to a maximum distance upper limit may be represented and classes having additional information 2 outside of the range are not emphasized. The distance range may vary as a function of the driving situation, for example, with respect to speed. In a parking maneuver, for example, only the distance range in the immediate vicinity of the host vehicle is relevant. However, ranges at a greater distance are also relevant when driving on a highway. On the basis of the available distance information, it is possible to decide whether this is inside or outside of the relevant distance range for each pixel.

The coloring will not be explained again with reference to FIG. 1. FIG. 1 shows that vehicle 10 is still slightly emphasized at the center of the intersection (preferably colored blue) in the background at the left, while objects at a greater distance are no longer emphasized because they are irrelevant for the instantaneous driving situation. For transitional areas or transition classes, for example, mixtures of colors may be used, so that a weighted averaging of camera image 11 and additional information 2 is performed in these areas. This results in sliding transitions between the classes and the colorations shown. Furthermore, class boundaries and/or additional information 2 may be smoothed to thus represent fuzziness. Errors are averaged and smoothed here, so the driver is not confused. The smoothing may be performed with regard to both time and space. Too much fuzziness may be counteracted by representing object edges, object contours, etc. Objects which are fuzzy due to the coloration are imaged more sharply in this way by using a contour representation. To minimize or prevent an impression of fuzziness associated with smoothing, additional lines and/or contours, for example, object edges, object contours, etc., may be represented using the Canny algorithm, for example, which finds and provides dominant edges of the camera image, for example.

FIG. 5 schematically shows three images from different steps for visualization of a traffic situation. A disparity image 20 is shown as an additional information image in the upper left image using a coloration indicating proximity (preferably represented by a red color) to far (preferably represented by blue color). The upper right image represents the result of a corresponding classification. The color red, for example, used for proximity means that the corresponding space-time point is located at a collision-relevant height. The lower image shows the visualization resulting from the two upper images. A different color scale is selected than that used in the upper images.

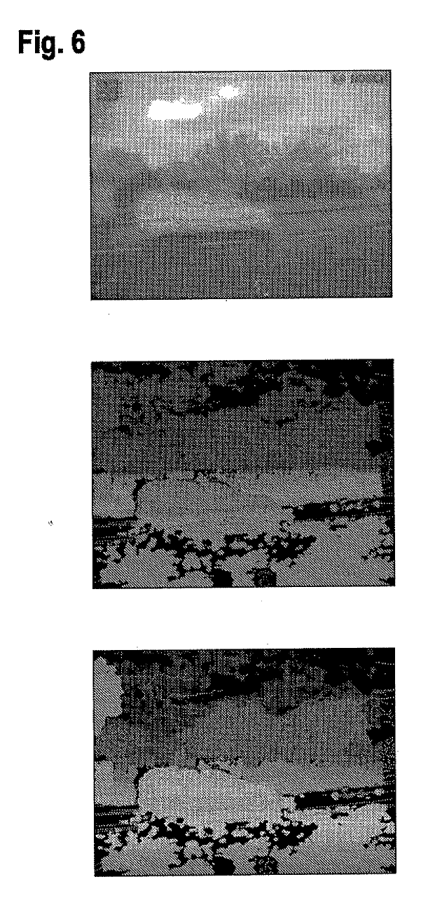

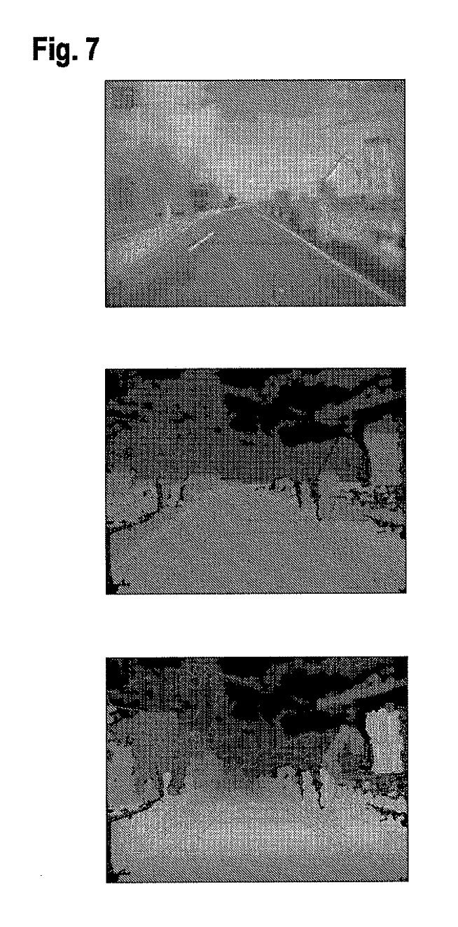

FIGS. 6 and 7 schematically show three images from different steps for a visualization of additional traffic situations. The principle of the visualization corresponds to the principles illustrated in FIG. 5.

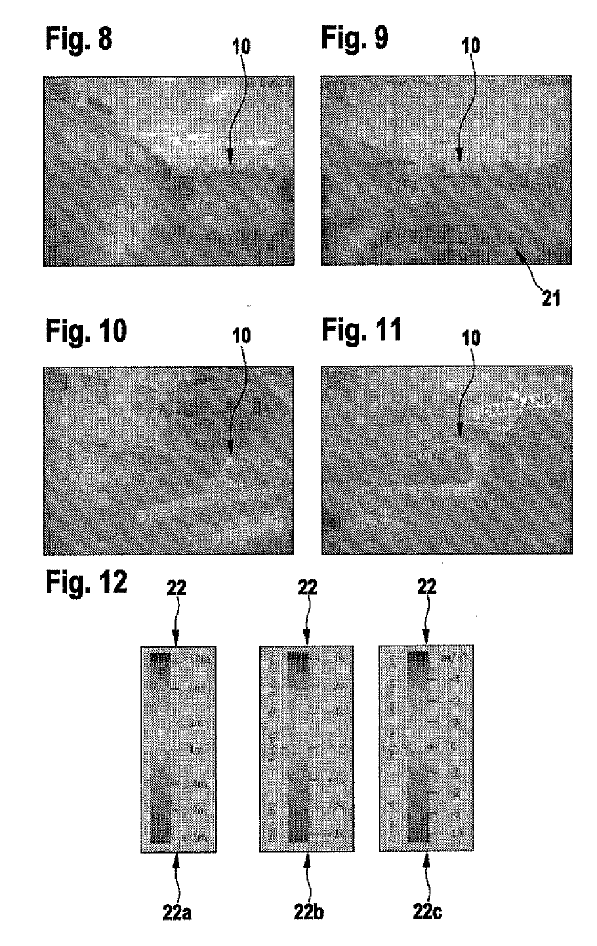

FIGS. 8 through 11 schematically show one image each of a visualization of four different parking situations. In FIG. 8, in forward parking, a vehicle 10 which is in the driving direction is still at a relatively great distance. In FIG. 9 the parking vehicle is relatively close to opposite vehicle 10, so that front area 21 above the opposite vehicle is marked as an obstacle, preferably in red. FIGS. 10 and 11 illustrate additional parking situations in which a vehicle 10 is situated obliquely to the direction of travel, so that corresponding vehicle 10 is represented in different colors according to additional information 2. Vehicle 10 is not labeled here as an object as a whole. Only the individual pixels are evaluated without a grouping into a “motor vehicle” object.

FIG. 12 schematically shows three scales 22 supplementing the visualization to facilitate orientation of a driver. First scale 22a is a metric scale, for example, using the meter as a unit. This scale 22a assigns a unit of length to each color used in the manner of a legend. However, other characterizations may also be included in the scale, for example, textures, brightness, hatching, etc. Second scale 22b is a time-distance scale, in the present case indicating the time until a collision. A time expressed in seconds as the unit of time is assigned to each color. In addition, instructions for a driving task (braking, following, accelerating) are also included. Third scale 22c has a value using m/s² as the unit for each color, i.e., denoting acceleration. Furthermore, instructions for a driving task are also shown here. The corresponding image is colored according to the characterization defined with the scale.

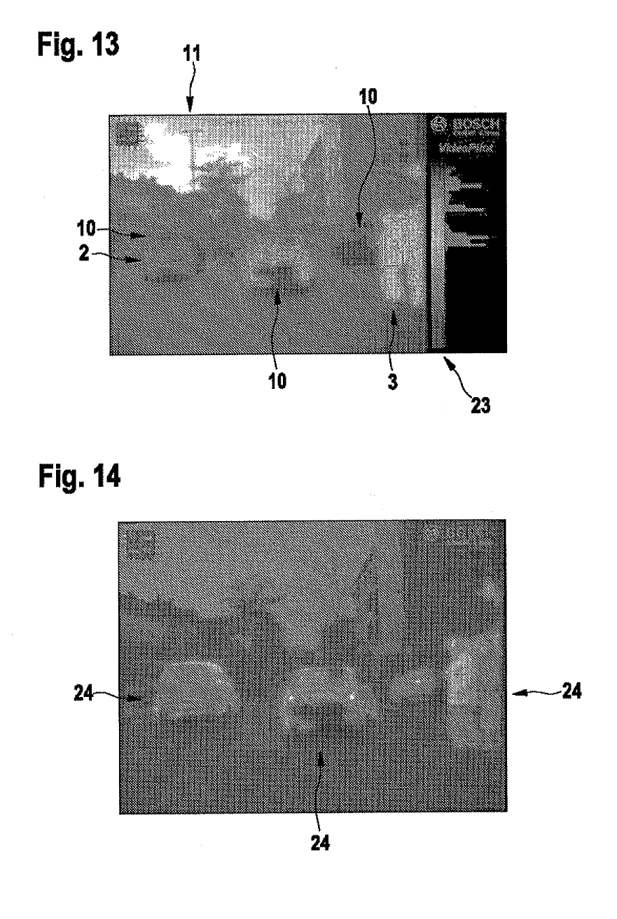

FIG. 13 schematically shows a visualization of a traffic situation using a supplementary histogram 23. Besides additional information 2, which is depicted as being superimposed in camera image 11, additional information 2 processed as histogram 23 is shown on the right edge of the image. Histogram 23 shows qualitatively and/or quantitatively which colors or which corresponding additional information values are occurring in the present situation and how often they occur. Four peaks are discernible in histogram 23. The two visible peaks in the area of a color, for example, the color yellow in the present case, stand for the distances from two people 3 on the edge of the road as shown in the figure in this exemplary embodiment. The next peak is to be found in another color, for example, in the range of turquoise green and stands for vehicle 10 driving in one's own lane in front. The fourth discernible peak is in the range of the color light blue, for example, and characterizes vehicle 10 in the left lane. Another weaker peak in the area of a dark blue color, for example, stands for vehicle 10, which is at a somewhat greater distance and has turned off to the right. The intensity of the color decreases continuously beyond predefined additional information 2, and objects at a greater distance are no longer colored. Vehicle 10, having turned off to the right, is already in an area where the intensity is declining. The change in intensity is also reflected in histogram 23. Further additional information such as the specific distance may also be taken into account, also as a function of the prevailing situation. In addition to camera image 11, other views may also be shown from the standpoint of the driver.

FIG. 14 schematically shows a visualization of a traffic situation using lightening of pixels instead of coloration. Image areas 24, which are known to contain collision-relevant objects, are visually lightened here, while the remaining image area is darkened. A sliding transition was selected, so that the representation is more attractive for the driver.

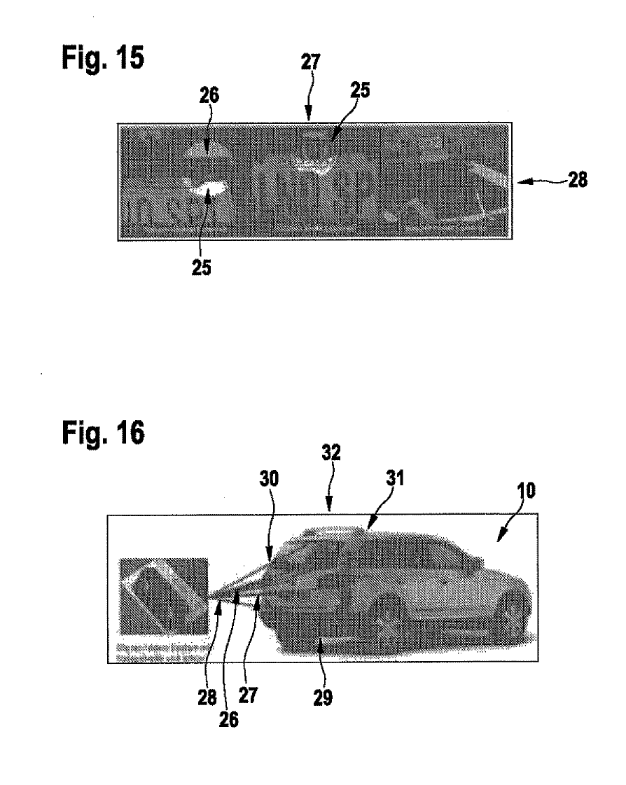

FIG. 15 schematically shows three different configurations for a camera 25 for implementing the image visualization. Cameras 25 are situated in such a way that they detect an area corresponding to the driving task at hand. In FIG. 15 this is the area behind the vehicle, i.e., the driving task is assisted driving in reverse. Cameras 25 may be designed as any cameras, for example, a monocular camera, optionally having an additional sensor for generating a distance image such as a Photonic mixing detector (PMD—hotonix mixer device), as a monochromatic camera or as a color camera, optionally with additional infrared lighting. The connection to a display may be either wireless or hard wired. To obtain additional information 2, at least one additional sensor is necessary, for example, a second camera, ultrasonic sensors, LIDAR sensors, radar sensors and the like. Cameras 25 are integrated into a trunk lid 26 in the first image, into a rear license plate 27 in the second image, and into a rear bumper 28 in the third image.

A corresponding system may be designed, for example, as a stereo camera system using analog and/or digital cameras, CCD or CMOS cameras or other high-resolution imaging sensors using two or more cameras/imagers/optics, as a system based on two or more individual cameras, and/or as a system using only one imager and suitable mirror optics. The imaging sensors or imaging units may be designed as any visually imaging device. For example, an imager is a sensor chip which may be part of a camera and is located in the interior of the camera behind its optics. Appropriate imagers convert light intensities into the appropriate signals.

In addition, at least one image processing computer is required. Processing of the image data may be performed within camera 25 (in the case of so-called “smart cameras”), in a dedicated image processing computer or on available computer platforms, for example, a navigation system. It is also possible for the computation operations to be distributed among multiple subsystems. The configuration of the camera system may vary as illustrated in FIG. 16.

FIG. 16 schematically shows different configurations for a stereo video system in a passenger motor vehicle 10. The camera system may be integrated into the recessed grip of trunk lid 27. In addition, the camera system may be integrated into trunk lid 26, for example, being extensible in the area of a vehicle emblem. An integrated configuration in bumper 28, in tail light and/or brake light unit 29, behind rear window 30, e.g., in the area of a third brake light, if any, which might optionally be present, in the B pillar, in C pillar 31, or in rear spoiler 32.

1-11. (canceled)

12. A method for visualizing image data having at least one piece of additional information, comprising:
representing the image data as an image data image having pixels, wherein the image data image is enriched relative to the image data with at least partial representation of additional information corresponding to individual pixels for generating the image data image at least one of enriched with the additional information and superimposed with the additional information.

13. The method as recited in claim 12, wherein the additional information is represented as classified by at least one of difference in coloration, texture, lightening, darkening, sharpening, enlargement, increased contrast, reduced contrast, omission, virtual illumination, inversion, distortion, abstraction, with contours, and variable over time including one of moving, flashing, vibrating, or wobbling.

14. The method as recited in claim 12, wherein the additional information is additionally represented in a processed representation at least one of: i) at least partially over the image data, and ii) next to the image data.

15. The method as recited in claims 12, wherein the additional information is additionally represented as a histogram.

16. The method as recited in claim 12 wherein at least one of the additional information and the image date are represented smoothed.

17. The method as recited in claim 12, wherein transitions are represented for a sharp localization of fuzzy additional information.

18. A storage device storing a computer program for visualizing image data having at least one piece of additional information, the computer program, when executed by a computer, causing the computer to perform the steps of:
representing the image data as an image data image having pixels, wherein the image data image is enriched relative to the image data with at least partial representation of additional information corresponding to individual pixels for generating the image data image at least one of enriched with the additional information and superimposed with the additional information.

19. A computer readable medium, storing a program code for visualizing image data having at least one piece of additional information, the program code, when executed by a computer causing the computer to perform the steps of:
representing the image data as an image data image having pixels, wherein the image data image is enriched relative to the image data with at least partial representation of additional information corresponding to individual pixels for generating the image data image at least one of enriched with the additional information and superimposed with the additional information.

20. A device for visualizing image data having at least one piece of additional information, the device, including an arrangement configured to represent the image data as an image data image having pixels, wherein the image data image is enriched relative to the image data with at least partial representation of additional information corresponding to individual pixels to generate image data image at least one of enriched with the additional information and superimposed with additional information.

21. The device as recited in claim 20, wherein the arrangement includes a display device adapted to represent additional information superimposed with respect to the image data.

22. The device as recited in claim 20, comprising:
at least one interface for coupling to system components to be connected, the system components including at least one of a driver assistance system, a motor vehicle, and additional sensors.

23. A system for visualizing image data for which at least one piece of additional information is available, the system comprising:
at least one of a stereo video-based driver assistance system, a monitoring camera system, a camera system for an aircraft, and a camera system for a watercraft; and
a device configured to represent image data as an image data image having pixels, wherein the image data image is enriched relative to the image date with at least partial representation of additional information corresponding to individual pixels to generate the image data image at least one of enriched with the additional information relative to the image data and superimposed with the additional information.
